(19) United States
(12) Patent Application Publication
(10) Pub. No.: US 2026/0014940 A1
(43) Pub. Date: Jan. 15, 2026

(54) COMPONENT FOR VEHICLE INTERIOR

(71) Applicant: Yanfeng International Automotive Technology Co. Ltd., Novi, MI (US)

(72) Inventors: He YANG, Shanghai (CN); Jing GU, Shanghai (CN); Fan YANG, Shanghai (CN)

(21) Appl. No.: 19/335,625

(22) Filed: Sep. 22, 2025

Related U.S. Application Data
(63) Continuation-in-part of application No. PCT/CN2024/082400, filed on Mar. 19, 2024.

(30) Foreign Application Priority Data
Mar. 22, 2023 (CN) 202310286758.5

(51) Int. Cl. B60R 13/02; B60Q 3/62

(52) U.S. Cl. CPC B60R 13/02; B60Q 3/62; B60Q 2500/00; B60R 2013/0287

(57) ABSTRACT

A component for a vehicle interior configured to present a composite visual effect is disclosed. The component may comprise a composite structure comprising a base and a cover and a light-transmitting element to transmit light to provide illumination and a reflecting element to provide reflected light. The composite visual effect may comprise visual effect of reflected light and/or visual effect of illumination and/or a visual effect from the cover and/or a visual effect from the base. The reflecting element and the light-transmitting element may be within the composite structure; the composite structure may comprise an open space. The composite visual effect may be presented at a surface of the cover; visual effect of illumination may comprise light transmitted through the composite structure. The cover may comprise a cover layer/material. The reflecting element may comprise a surface. The composite structure may comprise a light-transmissive material and/or an opaque material.

### CROSS-REFERENCE TO RELATED APPLICATIONS

The present application is a continuation-in-part of PCT/International Patent Application No. PCT/CN2024/082400 titled “VEHICLE OPTICAL INTERIOR TRIM PART” filed Mar. 19, 2024, that claims the benefit of Chinese Patent Application No. 202310286758.5 titled “VEHICLE OPTICAL INTERIOR TRIM PART” filed Mar. 22, 2023.

The present application claims priority to and incorporates by reference in full: (1) PCT/International Patent Application No. PCT/CN2024/082400 titled “VEHICLE OPTICAL INTERIOR TRIM PART” filed Mar. 19, 2024; and (2) Chinese Patent Application No. 202310286758.5 titled “VEHICLE OPTICAL INTERIOR TRIM PART” filed Mar. 22, 2023.

### FIELD

The present invention relates to a component for vehicle interior.

The present invention relates to a component for a vehicle interior configured to present a composite visual effect.

The present invention relates to a component for a vehicle interior configured to present a composite visual effect comprising a visual effect of reflected light and a visual effect of illumination.

### BACKGROUND

It is known to provide a component for a vehicle interior configured to present a visual effect.

It would be advantageous to provide an improved component for a vehicle interior configured to present a composite visual effect.

It would be advantageous to provide an improved component for a vehicle interior configured to present a composite visual effect comprising a visual effect of reflected light and a visual effect of illumination.

### SUMMARY

The present invention relates to a component for a vehicle interior configured to present a composite visual effect comprising a composite structure comprising a base and a cover and a light-transmitting element configured to transmit light to provide illumination for the composite structure and a reflecting element configured to provide reflected light; the composite visual effect may be configured to comprise illumination and reflected light presented at the composite structure. Illumination from the light-transmitting element may be configured to present a visual effect; reflected light from the reflecting element may be configured to present a visual effect. The composite visual effect may comprise the visual effect of reflected light from the reflecting element and the visual effect of illumination from the light-transmitting element. The reflecting element and the light-transmitting element may be within the composite structure. The composite structure may comprise an open space. The composite visual effect may be presented at a surface of the cover of the composite structure. The visual effect of illumination from the light-transmitting element may comprise light transmitted through the composite structure. The composite visual effect may comprise the visual effect of reflected light from the reflecting element and the visual effect of illumination from the light-transmitting element and a visual effect from the cover of the composite structure and/or a visual effect from the base of the composite structure. The composite structure may comprise an intermediate layer. The cover may comprise a cover layer; the cover layer may comprise a coating and/or a film and/or a material. The reflecting element may comprise a surface. The composite structure may comprise a light-transmissive material. The composite structure may comprise a generally opaque material. The composite structure may comprise a light-transmitting structure and/or a light-reflecting surface. The composite visual image may comprise at least one of a light effect and/or a dynamic lighting effect and/or a pattern effect and/or a texture effect and/or a color effect and/or a multi-color effect and/or a fabric effect and/or a brushed effect and/or a checkered effect and/or a gradient effect and/or a starry-sky effect and/or a stone-like effect and/or a wood grain effect and/or a textile effect and/or a landscape effect and/or a crystal effect and/or a layered effect and/or a lens effect and/or a three-dimensional effect and/or text and/or an image and/or a figure and/or a symbol and/or a number and/or a beacon and/or a logo. The composite structure may comprise a light-transmitting structure comprising a light-transmitting material comprising at least one of glass and/or plastic and/or film and/or wood vencer and/or leather and/or synthetic leather and/or stone vencer and/or elastomer and/or rubber and/or plastic and/or resin and/or fabric and/or textile and/or composite material and/or a flexible layer and/or a 3D mesh and/or a foamed layer and/or a foam material. The composite visual effect may be configured to comprise a visual effect of illumination comprising at least one of a decorative effect and/or a color effect and/or a pattern effect and/or a surface effect and/or a texture effect and/or a depth of field effect. The composite visual effect may be configured to comprise a visual effect of reflected light comprising at least one of a decorative effect and/or a color effect and/or a pattern effect and/or a surface effect and/or a texture effect and/or a depth of field effect. The composite visual effect may be configured to comprise at least one of a decorative effect and/or a color effect and/or a pattern effect and/or a surface effect and/or a texture effect and/or an illumination effect and/or a reflection effect and/or a light reflection effect and/or a light absorption effect and/or a light refraction effect and/or light transmission effect and/or light multi-reflection effect and/or light multi-transmission effect and/or a direct light effect and/or an optical effect and/or a combination of optical effects and/or a combination of illumination effects and/or a combination of reflective effects and/or a reflective effect and an illumination effect and/or a color effect and/or a multi-color effect and/or a superimposed illumination effect and/or a superimposed illumination effect by multi-reflection with refraction and/or an optical effect comprising an aesthetic effect and/or a multi-aesthetic effect and/or a varying optical effect and/or a dynamic lighting effect and/or a random pattern effect and/or a repeating pattern effect.

The present invention relates to a component for a vehicle interior comprising an interior trim part; the component may comprise a composite structure comprising a light-transmitting component comprising a base layer and a coating layer attached to a surface of the base layer and a reflecting component; the reflecting component and the light-transmitting component are arranged at an interval; light may be transmitted out of the light-transmitting component through the coating layer and is partially projected on the reflecting component so as to present an optical effect on a surface of the light-transmitting component and a surface of the reflecting component. The light-transmitting component may comprise at least one of a textured structure, a pattern, and a color formed on one surface of the base layer. The surface of the base layer may be formed with a textured structure; the coating layer is attached to the surface with the textured structure. The coating layer may comprise an opaque region and a light-transmitting region, at least the opaque region may be attached to the surface with the textured structure. The surface of the base layer corresponding to the light-transmitting region may have a textured structure or a smooth surface. The smooth surface or the surface with the textured structure may be formed with at least one of a pattern and a color. The surface of the base layer corresponding to the light-transmitting region has a textured structure different from a textured structure corresponding to the opaque region. The coating layer may be a single-layer film or a multi-layer film stacked together. The textured structure may present a texture effect comprising at least one of a brushed texture, a checkered texture, a gradient texture, a starry-sky texture, a stone-like texture, a wood grain texture, a textile texture, a landscape texture, a crystal texture, a lens texture, a three-dimensional relief, a text, a figure, a symbol, a number, a beacon, and a trademark. The pattern may comprise at least one of a texture, a figure, a text, a symbol, a number, a beacon and a trademark. The pattern and/or the color may be formed by a single-layer film or a coating layer or a multi-layer film stacked together. The light-transmitting component may comprise a light-transmitting surface layer that covers a surface of the light-transmitting component. The light-transmitting surface layer may comprise any one of glass, plastic, film, wood veneer, leather, stone vencer, rubber, resin, fabric, and/or composite material. The light-transmitting component may comprise a light-transmitting flexible layer interposed between the light-transmitting surface layer and the base layer. The light-transmitting flexible layer may comprise any one of a mesh, and a foamed layer. The reflecting component and the light-transmitting component are vehicle interior components. The interior trim part may comprise a light emitting component arranged between the reflecting component and the light-transmitting component. The interior trim part may be configured to provide a visual effect comprising at least one of the following effects (a) a decorative effect and/or a color effect and/or a pattern effect and/or a surface effect and/or a texture effect provided by the interior trim part; and/or (b) a depth of field effect and/or a decorative effect and/or a color effect and/or a pattern effect and/or a surface effect and/or a texture effect provided by the surface of the light-transmitting component and/or the surface of the reflecting component; and/or (c) an illumination effect provided by light transmitted through the interior trim part; and/or (d) an illumination effect provided by light transmitted through the interior trim part and the surfaces of the light-transmitting component and the reflecting component; (e) an optical effect; (f) a decorative effect. The interior trim part may comprise an optical interior trim part.

### FIGURES

FIG. 1A is a schematic perspective view of a vehicle according to an exemplary embodiment.

FIG. 1B is a schematic perspective view of an interior of a vehicle according to an exemplary embodiment.

FIGS. 1C through 1F are schematic perspective views of a component for an interior of a vehicle according to an exemplary embodiment.

FIGS. 2A through 2D are schematic diagrams of a composite structure of a component for an interior of a vehicle according to an exemplary embodiment.

FIGS. 3A through 3D are schematic diagrams of a composite structure of a component for an interior of a vehicle according to an exemplary embodiment.

FIG. 4A is a schematic section view of a component for an interior of a vehicle according to an exemplary embodiment.

FIG. 4B is a schematic side elevation view of a component for an interior of a vehicle according to an exemplary embodiment.

FIG. 5A is a schematic section view of a component for an interior of a vehicle according to an exemplary embodiment.

FIG. 5B is a schematic side elevation view of a component for an interior of a vehicle according to an exemplary embodiment.

FIGS. 6A and 6B are schematic perspective views of a component for an interior of a vehicle according to an exemplary embodiment.

FIGS. 7A and 7B are schematic perspective views of a component for an interior of a vehicle according to an exemplary embodiment.

FIG. 8 is a schematic diagram of light element for a component for an interior of a vehicle according to an exemplary embodiment.

FIG. 9 is a schematic side elevation view of a component for an interior of a vehicle according to an exemplary embodiment.

FIG. 10 is a schematic side elevation view of a component for an interior of a vehicle according to an exemplary embodiment.

FIGS. 11A and 11B are schematic views of a visual effect from a component for an interior of a vehicle according to an exemplary embodiment.

FIG. 12 is a schematic view of a visual effect from a component for an interior of a vehicle according to an exemplary embodiment.

FIG. 13 is a schematic view of a visual effect from a component for an interior of a vehicle according to an exemplary embodiment.

FIG. 14 is a schematic perspective view of a component for an interior of a vehicle according to an exemplary embodiment.

FIGS. 15A through 15C are schematic views of a visual effect from a component for an interior of a vehicle according to an exemplary embodiment.

FIG. 15D is a schematic diagram of a composite structure of a component for an interior of a vehicle according to an exemplary embodiment.

FIGS. 16A through 16C are schematic views of a visual effect from a component for an interior of a vehicle according to an exemplary embodiment.

### DESCRIPTION

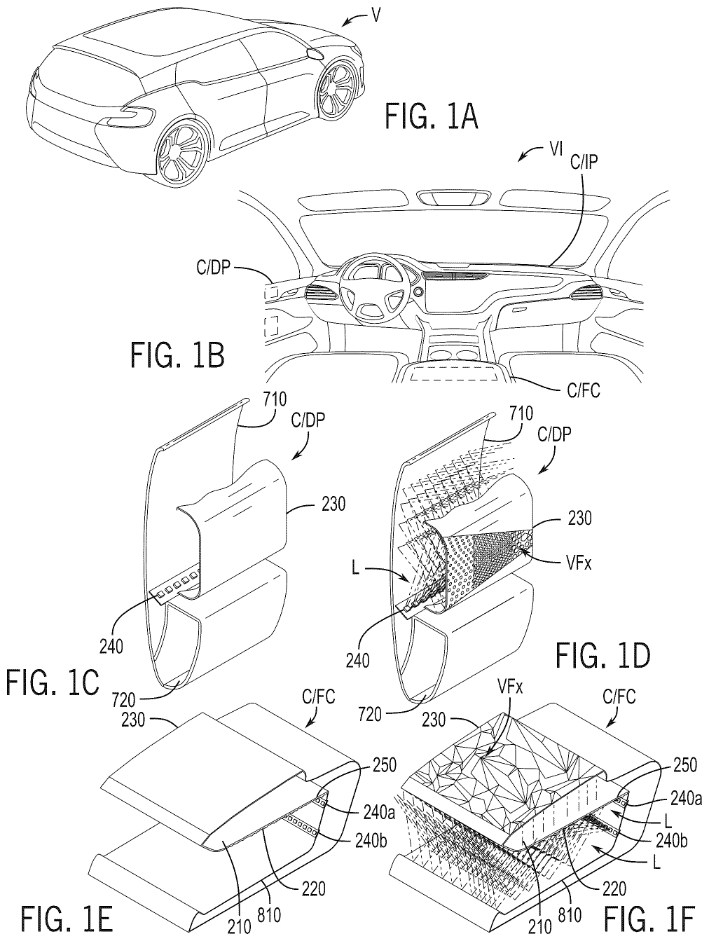

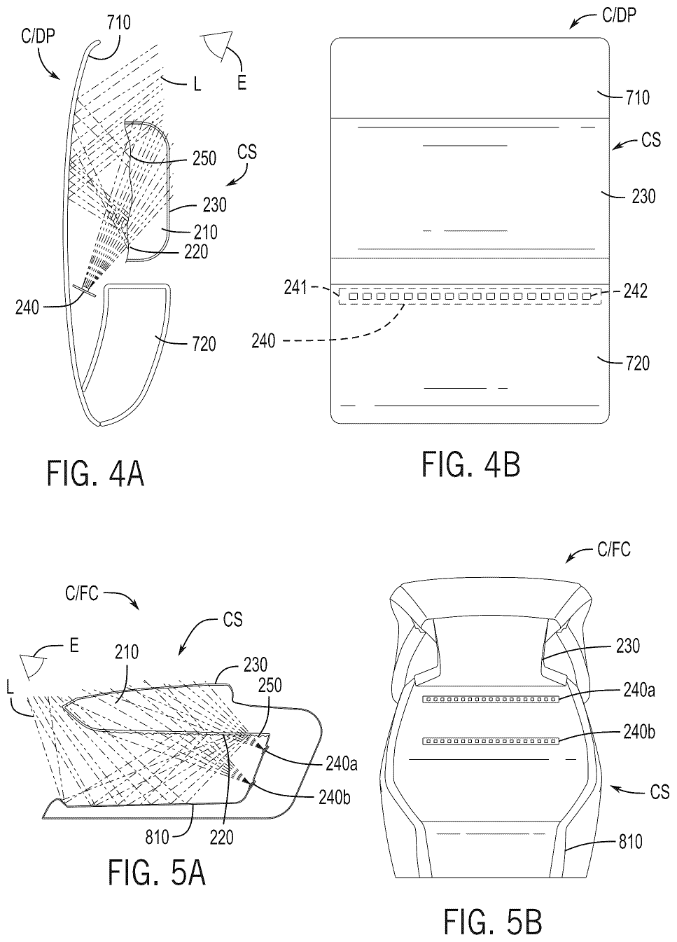

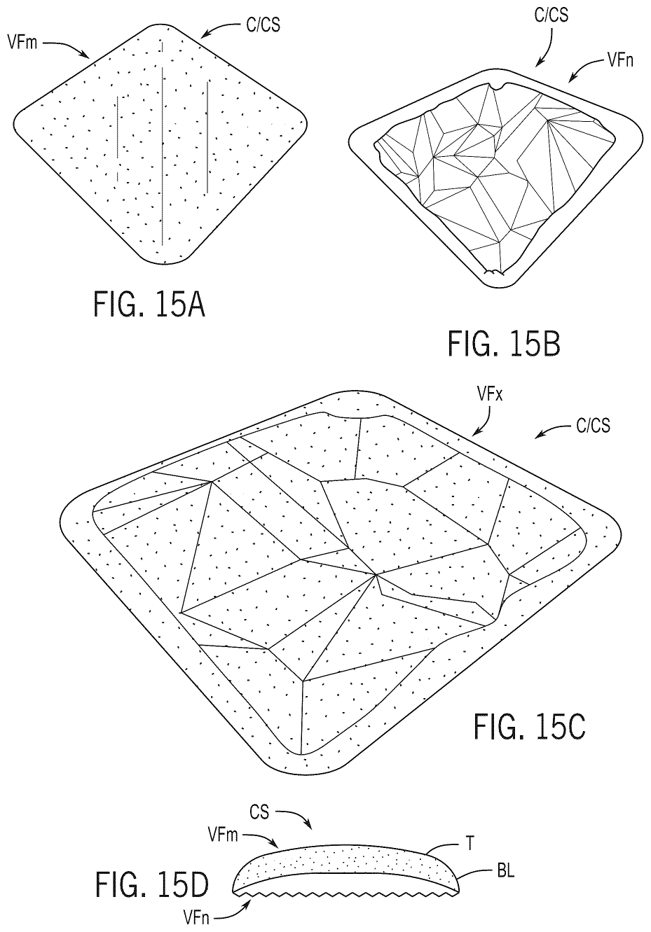

Referring to FIGS. 1A and 1B a vehicle V with an interior VI is shown according to an exemplary embodiment; vehicle interior may comprise components such as an instrument panel IP, door panel DP, console shown as floor console FC, etc. According to an exemplary embodiment as shown schematically in FIGS. 1B-1F, 2A-2D, 3A-3D, 14 and 15A-15D, the component C for a vehicle interior may comprise a composite structure CS configured to present a visual effect VF configured to comprise a composite visual effect VFx; the composite structure CS may comprise a base BL and a cover T and a light-transmitting element configured to transmit light to provide illumination L for the composite structure CS and a reflecting element configured to provide reflected light L; the composite structure CS may comprise an intermediate layer NL; the cover may comprise a cover layer T/TC; the cover layer T/TC may comprise a coating and/or a film and/or a material. See also FIGS. 4A-4B, 5A-5B, 6A-6B and 7A-7B.

As indicated schematically in FIGS. 1B-1F, 4A-4B, 5A-5B, 6A-6B and 7A-7B, the visual effect VF comprising composite visual effect VFx presented at the composite structure CS of the component C may be configured to comprise illumination L and reflected light L; illumination L from a light-transmitting element (such as LED panel 240) may be configured to present a visual effect VF; reflected light L from the reflecting element (such as a surface/panel or component) may be configured to present a visual effect VF. As indicated schematically in 1B-1F, 4A-4B, 5A-5B, 6A-6B and 7A-7B, the composite visual effect VFx may comprise the visual effect VF of reflected light L from the reflecting element and the visual effect VF of illumination L from the light-transmitting element.

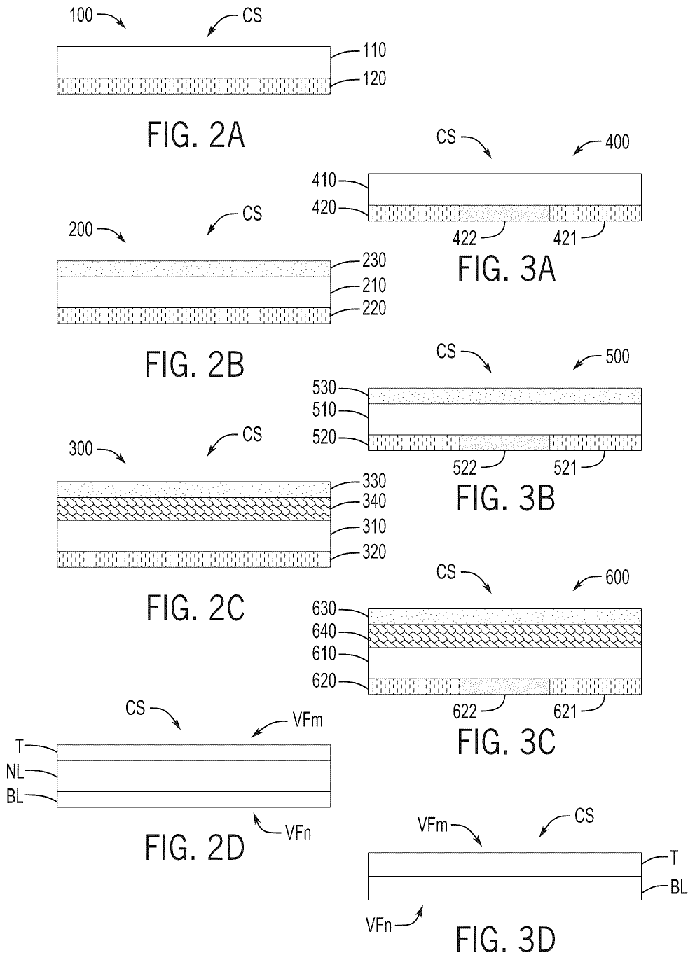

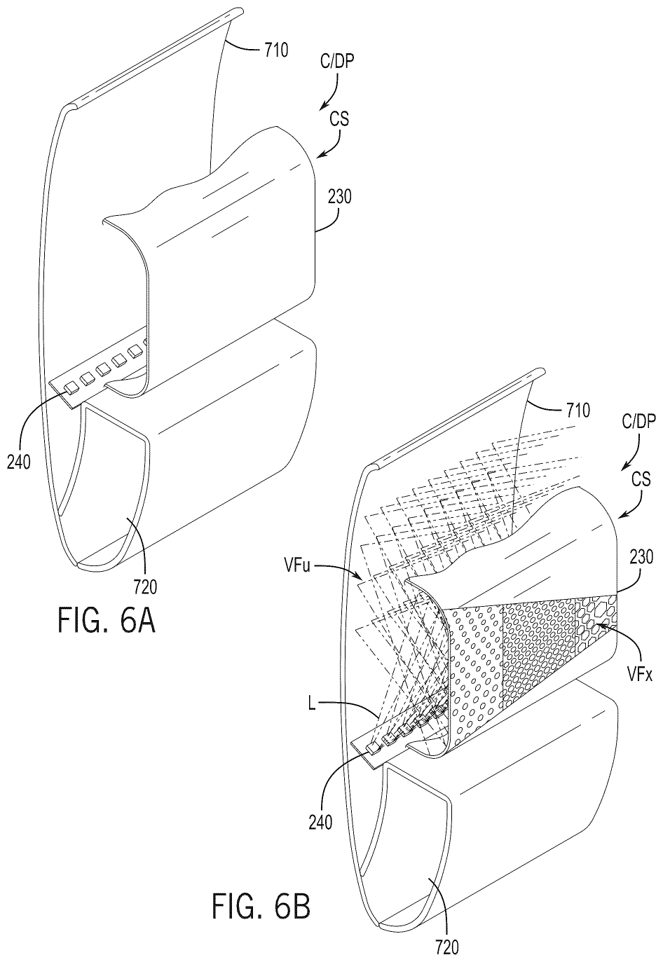

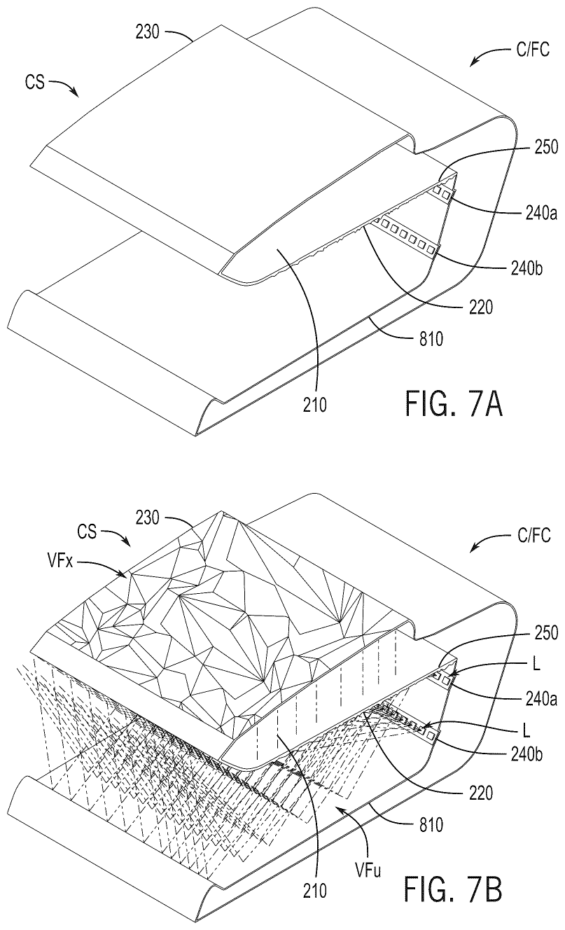

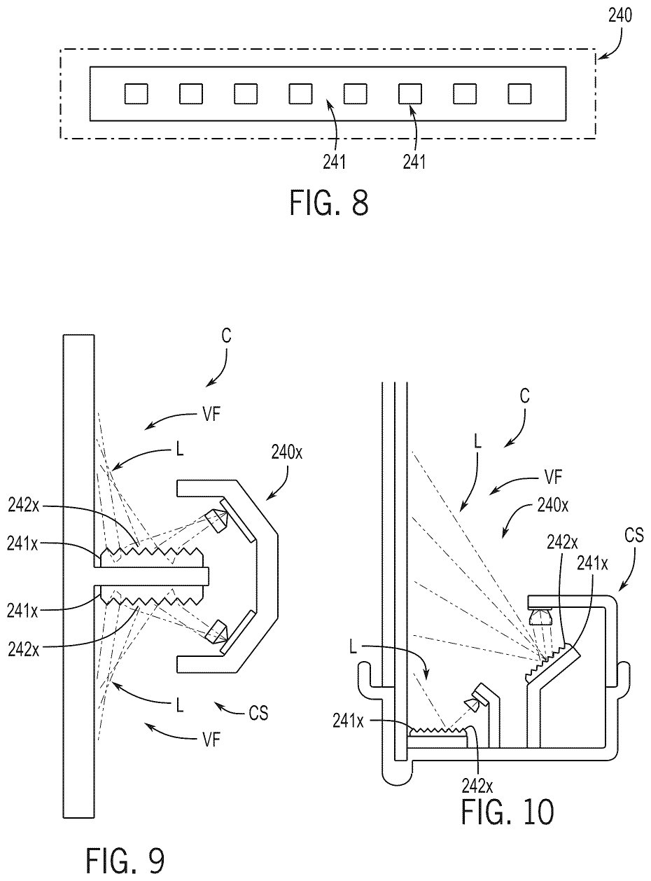

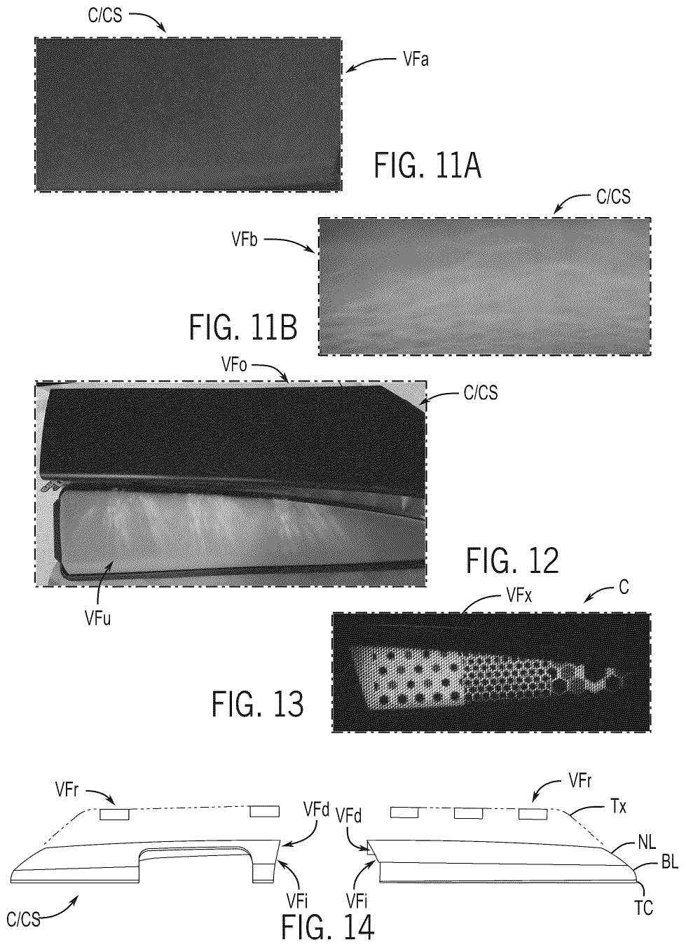

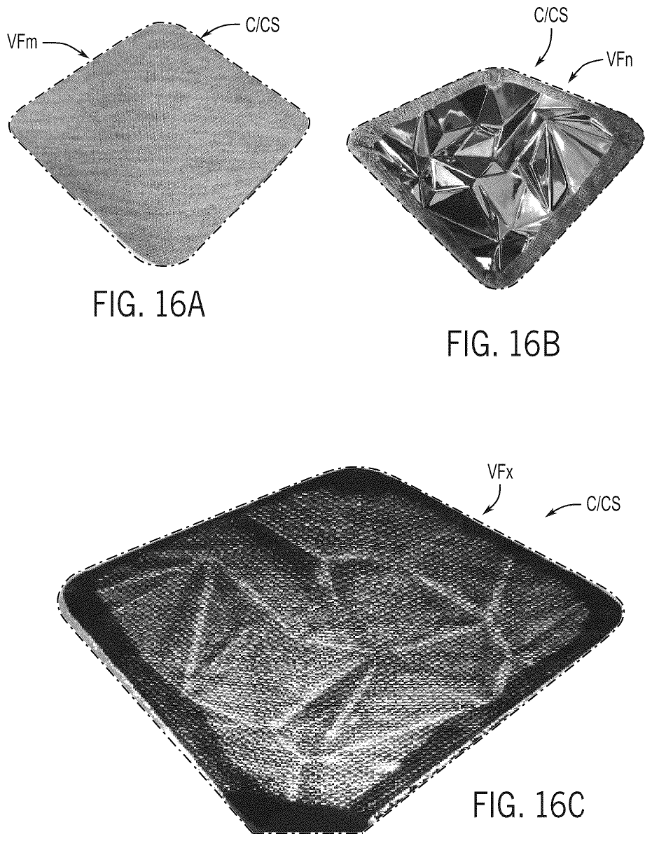

As indicated schematically in FIGS. 1C-1F, 4A-4B, 5A-5B, 6A-6B and 7A-7B, the composite visual effect VFx may be presented at a surface of the cover of the composite structure CS; the visual effect VF of illumination L from the light-transmitting element may comprise light transmitted through the composite structure CS; the visual effect VF of reflected light L may comprise light reflected from surfaces/element of the composite structure CS. As indicated schematically in FIGS. 4A-4B, 5A-5B, 6A-6B, 7A-7B, 11A-11B, 12, 13, 15A-15D and 16A-16C, the composite visual effect VFx may comprise the visual effect VF of reflected light L from the reflecting element and the visual effect VF of illumination L from the light-transmitting element and a visual effect VF from the cover of the composite structure CS and/or a visual effect VF from the base of the composite structure CS. See also FIGS. 1B-1F. As indicated schematically in FIGS. 1C-1F, 4A-4B, 5A-5B, 6A-6B and 7A-7B, the reflecting element and the light-transmitting element may be within the composite structure CS; the composite structure CS may comprise an open space/hollow area. As indicated schematically in FIGS. 2A-2D, 3A-3D, 4A-4B, 5A-5B, 6A-6B, 7A-7B, 11A-11B, 12, 13, 15A-15D and 16A-16C, the composite structure CS of component C may comprise a light-transmissive material; the composite structure CS may comprise a generally opaque material. As indicated schematically in FIGS. 4A-4B, 5A-5B, 6A-6B, 7A-7B, 11A-11B, 12, 13, 15A-15D and 16A-16C, the reflecting element may comprise a surface; the composite structure CS may comprise a light-transmitting structure and/or a light-reflecting surface. As indicated schematically in FIGS. 8, 9 and 10, the composite structure CS for component C may comprise a light assembly 240 with light elements such as LED elements 241 and/or reflecting surfaces 241x and/or reflecting elements 242x for light L provided from the light assembly/element 240x to provide a visual effect VF. As indicated schematically in FIGS. 11A-11B, 12 and 13, the component C may comprise a composite structure CS configured to provide a variety of visual effect VF; the visual effect VF may comprise a pattern effect and/or a varying effect VFa and VFb; the reflecting element for the composite structure CS may comprise a surface such as an interior surface configured to provide a visual effect VF such as visual effect VFu; the composite structure CS may comprise a light-transmitting structure configured to provide a visual effect VF such as visual effect VFo. See also FIGS. 6A-6B and 7A-7B. As indicated schematically in FIGS. 4A-4B, 5A-5B, 6A-6B and 7A-7B, the reflecting element of the composite structure CS may comprise a light-reflecting surface. See also FIGS. 9 and 10.

As indicated schematically in FIGS. 11A-11B, 12, 13, 15A-15D and 16A-16C, the composite structure CS for component C configured to present a visual effect VF may comprise a light-transmitting structure comprising a light-transmitting material comprising at least one of glass and/or plastic and/or film and/or wood vencer and/or leather and/or synthetic leather and/or stone veneer and/or elastomer and/or rubber and/or plastic and/or resin and/or fabric and/or textile and/or composite material and/or a flexible layer and/or a three-dimensional (3D) mesh and/or a foamed layer and/or a foam material. As indicated schematically in FIGS. 4A-4B, 5A-5B, 6A-6B, 7A-7B, 11A-11B, 12, 13, 15A-15D and 16A-16C, reflected light L from the reflecting element may be configured to present a visual effect VF; illumination L from the light-transmitting element is configured to present a visual effect VF. As indicated schematically in FIGS. 2A-2D, 3A-3C, 11A-11B, 12, 13, 15A-15D and 16A-16C, the base of the composite structure CS of the component C may comprise a base layer BL configured to provide a visual effect VFn; the cover of the composite structure CS is configured to provide a visual effect VF such as VFm; the composite visual effect VFx comprises the visual effect VF of reflected light L from the reflecting element and the visual effect VF of illumination L from the light-transmitting element and the visual effect VF from the cover of the composite structure CS and the visual effect VF from the base layer BL of the composite structure CS. See also FIG. 14 (composite structure CS configured to present internal/external visual effects shown as visual effect VFr and visual effect VFd and visual effect VFi).

As indicated schematically, the composite visual image may comprise at least one of a light effect and/or a dynamic lighting effect and/or a pattern effect and/or a texture effect and/or a color effect and/or a multi-color effect and/or a fabric effect and/or a brushed effect and/or a checkered effect and/or a gradient effect and/or a starry-sky effect and/or a stone-like effect and/or a wood grain effect and/or a textile effect and/or a landscape effect and/or a crystal effect and/or a layered effect and/or a lens effect and/or a three-dimensional effect and/or text and/or an image and/or a figure and/or a symbol and/or a number and/or a beacon and/or a logo. As indicated schematically, the composite visual effect VFx may be configured to comprise a visual effect VF of illumination L comprising at least one of a decorative effect and/or a color effect and/or a pattern effect and/or a surface effect and/or a texture effect and/or a depth of field effect. As indicated schematically, the composite visual effect VFx may be configured to comprise a visual effect VF of reflected light L comprising at least one of a decorative effect and/or a color effect and/or a pattern effect and/or a surface effect and/or a texture effect and/or a depth of field effect. As indicated schematically, the composite visual effect VFx may be configured to comprise at least one of a decorative effect and/or a color effect and/or a pattern effect and/or a surface effect and/or a texture effect and/or an illumination L effect and/or a reflection effect and/or a light reflection effect and/or a light absorption effect and/or a light refraction effect and/or light transmission effect and/or light multi-reflection effect and/or light multi-transmission effect and/or a direct light effect and/or an optical effect and/or a combination of optical effects and/or a combination of illumination L effects and/or a combination of reflective effects and/or a reflective effect and an illumination L effect and/or a color effect and/or a multi-color effect and/or a superimposed illumination L effect and/or a superimposed illumination L effect by multi-reflection with refraction and/or an optical effect comprising an aesthetic effect and/or a multi-aesthetic effect and/or a varying optical effect and/or a dynamic lighting effect and/or a random pattern effect and/or a repeating pattern effect.

As indicated schematically, illumination may be provided in the form of a light element such as a backlight; a visual effect of shadow/depth may be achieved by the refraction of light when the light/backlight is transmitted through the composite structure of the component; enhanced visual effects may be provided as the composite visual effect for the component, such as three-dimensional effects, dynamic effects, pattern changes, etc.; the visual effect may combine transmission and reflection; the visual effect may comprise an optical effect observed by a viewer such as a superimposed illumination effect comprising the composite visual effect; the visual effect may be formed by light after multiple reflection, transmission and refraction; the visual effect may comprise variations in illumination effect (e.g. lighted/lamp effect) and/or reflection effect to provide a visually unique/aesthetic effect; the structural design and materials of the composite structure may be combined to provide variations in the visual effect/visual effects provided by the component; distinctive decorative effects may also be created using material selection and design variations

According to an exemplary embodiment, the composite structure of the component C may combine static lighting and/or dynamic lighting and or depth of field/three-dimensional effects and/or light transmission and/or light reflection and/or light absorption and/or light refraction to produce a composite visual effect VFx.

### Exemplary Embodiments—A

According to an exemplary embodiment as shown schematically in the FIGURES, a component C for an interior VI of a vehicle V may comprise an improved interior trim part comprising a composite structure CS; the component C with the composite structure CS may comprise a light-transmitting component comprising a base layer and a coating layer and a reflecting component; the coating layer may be attached to a surface of the base layer; the component may be configured to provide a visual effect VF comprising an optical effect and/or an illumination effect and/or a decorative effect.

As indicated schematically in FIGS. 1A-1B, a component comprising an interior trim part may be implemented in a vehicle V that may comprise a vehicle interior structure such as a door panel DP, an instrument panel IP, and a sub-instrument panel shown as console FC. According to an exemplary embodiment, the interior trim part may be provided at any one of the interior structures of the vehicle. According to an exemplary embodiment, the interior trim part may be placed in any region in the unidentified car where a lighting application is desired. Conventional interior trim parts may usually be illuminated in the form of a uniform backlight; the effect of shadow/depth is achieved by the refraction of light when the backlight is transmitted through the interior trim parts. With the development of intelligent vehicles and the increasing demand of consumers for comfort and aesthetics, the interior trim parts still need to be improved in many aspects, in order to obtain more abundant visual effects, such as three-dimensional effects, dynamic pattern changes, etc.

According to an exemplary embodiment, a component may comprise an interior trim part comprising a light-transmitting component; the light-transmitting component may comprise a base layer and a coating layer; the coating layer may be attached to a surface of the base layer; a reflecting component and the light-transmitting component may be arranged at an interval; incident light is transmitted out of the light-transmitting component through the coating layer and is partially reflected to the reflecting component so as to present a visual/optical effect on a surface of the light-transmitting component and a surface of the reflecting component.

According to an exemplary embodiment, the component may combine transmission and reflection by means of the light-transmitting component in such a way that a viewer may simultaneously observe a rich level of optical effects on the light-transmitting component and the reflecting component. In combination with the distribution of the positions of the light emitting components emitting incident light and/or the ratio of different light sources (colors, light intensities, etc.), even if the observation angle or the observation region is fixed, the interior trim parts may present varying lighting effects creating vivid and distinctive visual effects without being limited to the existing limitations such as the interior space of the vehicle.

According to an exemplary embodiment, the reflecting component and the light-transmitting component are internal structures of the vehicle the door panel DP and the sub-instrument panel FC described below by way of example with reference to the accompanying drawings serve as the reflecting component for providing the reflecting surface, the armrest and the trim or cover above the sub-instrument panel serve as the light-transmitting component for providing the light-transmitting portion, and the light emitting component is arranged between the reflecting component and the light-transmitting component, so that a viewer may observe the optical effect on the surface of the light-transmitting component and the surface of the reflecting component. According to an exemplary embodiment, the surface of the light-transmitting component and the surface of the reflecting component refer to surfaces that are generally directed toward the viewer. Depending on the different requirements, the reflected surface may be selected according to the arrangement of the light emitting component and the overall shape of the vehicle interior.

According to an exemplary embodiment as indicated schematically in FIGS. 2A-2C and 3A-3C, the composite structure of component may be configured in any of a variety of arrangements with any of a variety of layers/materials to provide a variety of visual effects for the component; arrangement and selection of layers/materials for the composite structure may be configured to provide variations in the optical performance of the component including light-transmission/reflection/absorption and variations in the corresponding visual effect VF (e.g. at cover/surface of the component).

According to an exemplary embodiment, the light-transmitting component 100 of the embodiment shown in FIG. 2A may comprise a base layer 110 and a coating layer 120 attached to a surface of the base layer 110 a surface facing a direction in that light is incident, i.e. a lower surface in FIG. 2A. According to an exemplary embodiment, the lower surfaces are the incident surfaces into that incident light enters.

According to an exemplary embodiment, the base layer 110 may comprise any one of glass, plastic, wood vencer, film, and leather, and may be set to have a color according to actual needs. According to an exemplary embodiment, the base layer 110 may be polycarbonate (PC), or polymethyl methacrylate (PMMA), polyethylene terephthalate (PET), polyolefin (PO), polyvinyl chloride (PVC), ethylene vinyl acetate (EVA), other suitable composite plastics, etc.

According to an exemplary embodiment, the coating layer 120 may be a physical vapor deposition (PVD) film layer formed by a vacuum coating technique such as evaporation coating or magnetron sputtering coating, and may be a single-layer film or a multi-layer film stacked together. The coating layer may comprise a metal coating layer and a non-metal coating layer the coating layer may be selected from a metal coating material such as indium or tin, or a non-metal coating material such as silicon dioxide, carbon dioxide and nitrogen. The coating layer generally has a metallic luster and has a high reflection property, so that the surface gloss of the light-transmitting component may be increased to give the light-transmitting component a metallic technical appearance. According to an exemplary embodiment, a part of the incident light is reflected at the lower surface of the coating layer 120 using the reflective property of the coating layer 120, and a part of the light is transmitted through the base layer 110 at the upper surface thereof due to the light-transmitting property of the coating layer 120 itself. According to an exemplary embodiment, the above-described optical effects presented on the surface of the light-transmitting component and the surface of the reflecting component are achieved by the semi-transmitting and semi-reflective property of the coating layer. According to an exemplary embodiment, the coating layer may have a color.

According to an exemplary embodiment, the light-transmitting component may comprise at least one of a textured structure, pattern, and color formed on one surface of the base layer, the color effect may be provided by the color characteristics of the base layer and/or the coating layer itself, and in certain embodiments, the color effect may be provided by a separate color layer. The color layer may be a single-layer film or coating or a multi-layer film stacked together.

According to an exemplary embodiment, the textured structure refers to a micro-or nano-scale three-dimensional (3D) microstructure, e. g. in the form of microscopic V-grooves, arc-shaped grooves or the like concave structures, or in the form of raised convex structures, that may be formed by different structural forms and/or the size/distribution of the various structural forms as a stereo-texture-imitating effect, a relief effect or the like, preferably formed on at least one surface by transfer or embossing of a photocurable adhesive by a transfer technique. Textured structure may be created by machining or chemical etching or photolithography or other processes that achieve the same result, depending on the needs. According to an exemplary embodiment, such as where the textured structure is to be transferred or embossed using a photocurable adhesive, the photocurable adhesive may itself be colored such that the visual effect presented is a color change.

According to an exemplary embodiment, the surface of the base layer 110 is formed with a textured structure, and the coating layer 120 is preferably attached to the surface with the textured structure as a highly reflective layer, but is not intended to be limiting, and may be arranged on a surface without the textured structure in some occasions. By combining the uniformly or non-uniformly distributed textured structure of the surface of the base layer with the coating layer, the surface of the light-transmitting component may feel the texture change effect in the case of external ambient light, or the visual effect of texture change in the case of the backlight provided by the light emitting component (the incident light is incident from the lower surface of FIG. 2A), and the experience is more abundant. According to an exemplary embodiment, the coating layer may increase the reflection of light enhancing the texture effect.

According to an exemplary embodiment, the textured structure presents a texture effect including at least one of a brushed texture, a checkered texture, a graded texture, a star-sky texture, a stone-like texture, a wood grain texture, a textile texture, a landscape texture, a crystal texture, a lens texture, a three-dimensional relief, a text, a figure, a symbol, a number, a beacon, and a trademark.

According to an exemplary embodiment, the pattern may be formed by a single-layer film or a coating layer or a multi-layer film stacked together. According to an exemplary embodiment, the pattern may be formed on the surface of the base layer by a process such as ink printing. According to an exemplary embodiment, the pattern may comprise at least one of a texture, a figure, a text, a symbol, a number, a beacon and a trademark. According to an exemplary embodiment, the patterned ink material may have a color to add varying levels of visual effect.

According to an exemplary embodiment as shown schematically in FIG. 2B, the light-transmitting component 200 may comprise a base layer 210 and a coating layer 220 attached to a surface of the base layer 210 facing a direction in that light is incident. According to an exemplary embodiment, the light-transmitting component 200 may comprise a light-transmitting surface layer 230, that covers the surface of the light-transmitting component 200, that is, the upper surface facing the viewer in FIG. 2B. According to an exemplary embodiment, the light-transmitting surface layer 230 may comprise any one of glass, plastic, film, wood veneer, leather, stone veneer, rubber, resin, fabric, and composite material. According to an exemplary embodiment, the surface of the light-transmitting component 200 may present a unique decorative effect in combination with the light-transmitting property of the light-transmitting surface layer 230 and the surface property of the material.

According to an exemplary embodiment as shown schematically in FIG. 2C, the light-transmitting component 300 may comprise a base layer 310 and a coating layer 320 attached to a surface of the base layer 310 facing a direction in that light is incident. According to an exemplary embodiment, the light-transmitting component 300 may comprise a light-transmitting surface layer 330 covering the surface of the light-transmitting component 300, and a light-transmitting flexible layer 340 sandwiched between the light-transmitting surface layer 330 and the base layer 310. According to an exemplary embodiment, the light-transmitting flexible layer may comprise any one of a 3D mesh, and a foamed layer. According to an exemplary embodiment, the light-transmitting component 300 may increase the flexible feel when touched by the viewer and the experience is richer than in the embodiment shown in FIG. 2B.

According to an exemplary embodiment, the light-transmitting component 100, 200, 300 utilizes the semi-transmitting and semi-reflective property of the coating layer to obtain the optical effect presented by the surface of the light-transmitting component and the surface of the reflecting component, the optical effect presented by the surface of the light-transmitting component mainly resulting from the design of the base layer, such as the textured structure. In some cases, in order to meet the high light transmission requirement of a partial region and to make visual effects such as textures and/or patterns clearer, the light-transmitting component of the component may advantageously be provided in that the coating layer may comprise an opaque region and a light-transmitting region, at least the opaque region being attached to the surface with a textured structure. The opaque region is provided with a coating such as ink to reduce the light transmittance of the region, and the manner in that the light transmittance is reduced is not limited herein. According to an exemplary embodiment, the optical effect presented by the surface of the light-transmitting component may be a superposition of the designs of both the base layer and the coating layer, such as a superposition of the textured structure and/or the shape of the light-transmitting regions.

According to an exemplary embodiment, the light-transmitting component 400 of the embodiment shown in FIG. 3A may be similar to the light-transmitting component 100 of the embodiment shown in FIG. 2A; the component may comprise a base layer 410 and a coating layer 420 attached to a surface of the base layer 410, the coating layer 420 may comprise an opaque region 421 and a light-transmitting region 422. The light-transmitting region 422 has a higher light transmission rate so that the region presents a clearer visual effect. According to an exemplary embodiment, the light-transmitting regions are attached to a surface with a textured structure to make the texture effect of the regions clearer. According to an exemplary embodiment, the surface of the base layer corresponding to the light-transmitting region has a textured structure different from the textured structure corresponding to the opaque region; alternatively, in certain embodiments, the surface of the base layer corresponding to the light-transmitting regions may be smooth, i. e. not provided with a textured structure. According to an exemplary embodiment, the light-transmitting regions may form more prominent visual differences than opaque regions having a textured structure or opaque regions having a different textured structure presenting a different visual effect. According to an exemplary embodiment, in the case where the coating surface of the opaque region 421 is provided with an ink coating layer, incident light from below the light-transmitting component 400 propagates toward the coating layer 420, and the light penetrates the light-transmitting region 422 having a corresponding textured structure without penetrating or partially penetrating the opaque region 421, so that on the surface of the light-transmitting component, the light-transmitting region 422 presents a clear texture effect different from that of the opaque region 421, and the ink at the opaque region 421 may be patterned to obtain a visual effect combined with the texture effect. A similar unique visual effect may be obtained when the surface of the base layer corresponding to the light-transmitting region 422 is smooth. According to an exemplary embodiment, the smooth surface or the surface with the textured structure is formed with at least one of a pattern and a color. According to an exemplary embodiment, specific textured structures and/or patterns and/or colors may be visualized with differently designed opaque regions and light-transmitting regions.

According to an exemplary embodiment, the coating layer may be a single-layer film or a multi-layer film stacked together. In order to obtain a light-transmitting region, when the coating layer is a single-layer film, a local region of the single-layer film is an oxide medium, and a peripheral region is a metal medium or a mixed medium of the metal medium and the oxide medium. The local region of the oxide medium achieves a metallic luster effect, but has a higher light transmittance so that a light-transmitting region, such as a beacon pattern, may be formed. In the case of other opaque regions having a textured structure requiring high reflection a metal medium or a mixed medium of a metal medium and an oxide medium may be used to increase the reflection of light enhancing the texture effect. When the coating layer is a multi-layer film, the multi-layer film may comprise at least one layer of an oxide medium and at least one layer of a metal medium or a mixed medium of a metal medium and an oxide medium, the effects may be obtained.

According to an exemplary embodiment, light-transmitting regions of locally high light transmission of the coating layer may be obtained by a de-plating process. According to an exemplary embodiment, after the metal medium film is plated using a conventional process, the metal medium in portions of the desired light-transmitting regions is etched away using a de-plating process and the oxide medium film is filled forming the light-transmitting regions. According to an exemplary embodiment, the desired light-transmitting region may be obtained by partially filling the coating with a different medium after shielding the local region during the coating.

According to an exemplary embodiment, the light-transmitting component 500 of the embodiment shown in FIG. 3B may be similar to the light-transmitting component 200 of the embodiment shown in FIG. 2B; the component may comprise a base layer 510 and a coating layer 520 attached to a surface of the base layer 510; the coating layer 520 may comprise an opaque region 521 and a light-transmitting region 522. According to an exemplary embodiment, the light-transmitting component 500 may comprise a light-transmitting surface layer 530, that covers the surface of the light-transmitting component 500.

According to an exemplary embodiment as indicated schematically in FIG. 3C, the light-transmitting component 600 may be similar to the light-transmitting component 300 (sec FIG. 2C) and may comprise a base layer 610 and a coating layer 620 attached to a surface of the base layer 610; the coating layer 620 may comprise an opaque region 621 and a light-transmitting region 622. According to an exemplary embodiment, the light-transmitting component 600 may comprise a light-transmitting surface layer 630 covering the surface of the light-transmitting component 600, and a light-transmitting flexible layer 640 sandwiched between the light-transmitting surface layer 630 and the base layer 610.

According to an exemplary embodiment, the design of the different structural layers of the light-transmitting component and the superimposition of the textured structures and/or patterns and/or colors with each other in the interior trim part of the component make it possible to obtain a unique visual effect shown as an optical/decorative effect under the illumination of the light emitting components.

According to an exemplary embodiment shown schematically in FIGS. 4A-4B, the component may be provided on/as a door panel DP of a vehicle; as indicated schematically, the door panel DP may serve as a reflecting component, a reflected surface 710 is provided, and a light-transmitting component and the reflecting component are arranged at an interval and exemplified by a light-transmitting component 200 having a base layer 210, a coating layer 220, and a light-transmitting surface layer 230 as shown in FIG. 2B. The light-transmitting component may be a vehicle component at the periphery of the door panel, such as an armrest or other suitable component. According to an exemplary embodiment, the surface of the base layer 210 is formed with a textured structure 250, and the coating layer 220 is attached to the surface of the textured structure 250. The light emitting component 240 is arranged at the map tape 720 of the door panel (for example, by means of a bracket or the like), and emits light toward the light-transmitting component. Due to the semi-transmitting and semi-reflective property of the coating layer 220, a portion of the light passing through the light-transmitting component present optical effects such as texture effects and/or patterns and/or colors on the outer surface (the light-transmitting surface layer 230) facing the viewer, while a portion of the light are reflected by the coating layer 220 toward the reflected surface 710, and then enter the viewing angle E of the viewer after being reflected again on the reflected surface 710. According to an exemplary embodiment, the combination of light transmission and reflection in different regions of the door panel may be observed by a viewer, experiencing a different experience than a conventional light atmosphere.

The light emitting component 240 is a point-shaped or line-shaped light source, such as a light emitting diode (LED) lamp bead or a LED light emitting strip, and one or more LED lamp beads may be arranged according to different requirements. A plurality of RGB integrated lamp beads 242 disposed on a PCB plate 241 by a SMT (surface mount technology) process is illustratively shown in FIG. 4B. According to an exemplary embodiment, in combination with the design and control of the light emitting component 240 the lighting state and/or color and/or light intensity and/or lighting time of one or more LED, not only may the various rich and varied optical effects be realized, but the dynamic/static light effects may be realized by separately or simultaneously lighting running water, flickering, breathing, depth feeling, etc. that may enrich the light effect and meet the requirements of certain specific scene atmosphere.

FIGS. 5A-5B show an embodiment applied to a sub-instrument panel FC region of a vehicle, in that the sub-instrument panel FC is provided as a reflecting component with a reflected surface 810, and the light-transmitting component is exemplified by a light-transmitting component 200 having a base layer 210, a coating layer 220, and a light-transmitting surface layer 230 as shown in FIG. 2B, and the surface of the base layer 210 is formed with a textured structure 250, and the coating layer 220 is attached to the surface of the textured structure 250. In the embodiment, the light-transmitting component may be a vehicle component at the periphery of the sub-instrument panel, such as a trim or cover over the sub-instrument panel or other suitable component. According to an exemplary embodiment, a portion of the incident light emitted by the light emitting components 240a, 240b passes through the light-transmitting component to present an optical effect such as a texture effect and/or a pattern and/or a color on the outer surface (the light-transmitting surface layer 230) facing the viewer, while a portion of the light are reflected by the coating layer 220 toward the reflected surface 810, and then enter the viewing angle E of the viewer after being reflected again on the reflected surface 810. According to an exemplary embodiment, two sets of light emitting components 240a, 240b arranged at an interval may be provided to achieve a richer dynamic lighting effect by time-sharing the illumination of one or more LED in different sets of light emitting components.

According to an exemplary embodiment, the interior trim part of the component may combine transmission and reflection; the optical effect observed by a viewer may comprise a composite visual effect VFx; the visual effect may comprise a superimposed illumination effect formed by light after multiple reflection, transmission and refraction; the illumination effect (e.g. lighted/lamp effect) may be visually unique/aesthetic; the visual effect may present/provide an experience effect that cannot be obtained by conventional components. Based on the structural design of the light-transmitting component and the light emitting component, a unique and distinctive decorative effect may be created. Depending on different application requirements and application scenarios, the interior trim part of the component may provide at least one of the following optical effects: (a) a decorative effect and/or a color effect and/or a pattern effect and/or a surface effect and/or a texture effect provided by the interior trim part, and/or (b) a depth of field effect and/or a decorative effect and/or a color effect and/or a pattern effect and/or a surface effect and/or a texture effect provided by the surface of the light-transmitting component and/or the surface of the reflecting component, and/or (c) an illumination effect provided by incident light transmitted through the interior trim part, and/or (d) an illumination effect provided by incident light transmitted through the interior trim part and the surfaces of the light-transmitting component and the reflecting component; (e) an optical effect; (f) a decorative effect; (g) a composite visual effect; (h) a composite visual effect comprising a combination of illumination effects; (i) a composite visual effect comprising a combination of illumination effect with light comprising transmission and/or reflection and/or absorption.

### Exemplary Embodiments—B

With the rapid development of the automotive industry and the ever-increasing demand for vehicle functionality, consumers tend to be more aesthetically pleasing for the vehicle interior components. Due to the unique advantages of lighting technology in atmosphere creation, human-computer interaction and riding experience, all kinds of new technologies combined with lighting in the automobile cockpit are being continuously developed and have been greatly developed. Conventional vehicle interior trim parts with illumination effects may be limited to the traditional lighting decorative solutions such as perforated light transmission, decorative light transmission film, light guide strip, etc. In such conventional parts, decorative, luxurious, and technological feel may be limited by materials and lighting technology; such conventional parts may not provide complex three-dimensional lighting effects and functions and may not provide satisfactory illumination effects. Such conventional parts may lack a high-end, luxurious, and technological feel of multi-level three-dimensional lighting decoration. Such conventional parts may fail to satisfy the increasing demand of the end users.

According to an exemplary embodiment as shown schematically in the FIGURES, an component for a vehicle interior may comprise an improved interior trim part comprising a composite structure; the component with the composite structure may comprise a light-transmitting component comprising a base layer and a coating layer and a reflecting component; the coating layer may be attached to a surface of the base layer; the reflecting component and the light-transmitting component may be arranged at an interval; incident light is transmitted out of the light-transmitting component through the coating layer and is partially reflected to the reflecting component, so as to present an optical effect on a surface of the light-transmitting component and a surface of the reflecting component.

According to an exemplary embodiment, rich and changeable reflection and transmission light effects may be provided for light transmittance; the aesthetics and comfort of the interior trim part during use may be improved. The component may be compact in structure, easy to assemble and low in cost. The component may be configured to be applied in various occasions to meet diversified requirements of users and improve the use experience. According to an exemplary embodiment, a component may be configured to provide a rich level of visual effect through an optimized design of the internal structure and light transmittance. According to an exemplary embodiment a component may comprise a light-transmitting component, the light-transmitting component comprising a base layer and a coating layer, and the coating layer being attached to a surface of the base layer; and a reflecting component, the reflecting component and the light-transmitting component being arranged at an interval, wherein, incident light is transmitted out of the light-transmitting component through the coating layer and is partially projected on the reflecting component, so as to present an optical effect on a surface of the light-transmitting component and a surface of the reflecting component.

As shown schematically in the FIGURES, the part/component may comprise any one or more of the features indicated according to an exemplary embodiment. According to an exemplary embodiment, the light-transmitting component comprises at least one of a textured structure, a pattern, and a color formed on one surface of the base layer. According to an exemplary embodiment, a surface of the base layer is formed with a textured structure, and the coating layer is attached to the surface with the textured structure. According to an exemplary embodiment, the coating layer comprises an opaque region and a light-transmitting region, at least the opaque region being attached to the surface with the textured structure. According to an exemplary embodiment, a surface of the base layer corresponding to the light-transmitting region has a textured structure or is smooth. According to an exemplary embodiment, the smooth surface or the surface with the textured structure is formed with at least one of a pattern and a color. According to an exemplary embodiment, a surface of the base layer corresponding to the light-transmitting region has a textured structure different from a textured structure corresponding to the opaque region. According to an exemplary embodiment, the coating layer is a single-layer film or a multi-layer film stacked together. According to an exemplary embodiment, the textured structure presents a texture effect comprising at least one of a brushed texture, a checkered texture, a gradient texture, a starry-sky texture, a stone-like texture, a wood grain texture, a textile texture, a landscape texture, a crystal texture, a lens texture, a three-dimensional relief, a text, a figure, a symbol, a number, a beacon, and a trademark. According to an exemplary embodiment, the pattern comprises at least one of a texture, a figure, a text, a symbol, a number, a beacon and a trademark. According to an exemplary embodiment, the pattern and/or the color are formed by a single-layer film or a coating layer or a multi-layer film stacked together. According to an exemplary embodiment, the light-transmitting component comprises a light-transmitting surface layer that covers a surface of the light-transmitting component. According to an exemplary embodiment, the light-transmitting surface layer comprises any one of glass, plastic, film, wood veneer, leather, stone veneer, rubber, resin, fabric, and composite material. According to an exemplary embodiment, the light-transmitting component comprises a light-transmitting flexible layer interposed between the light-transmitting surface layer and the base layer. According to an exemplary embodiment, the light-transmitting flexible layer comprises any one of a 3D mesh, and a foamed layer. According to an exemplary embodiment, the reflecting component and the light-transmitting component are vehicle interior components. According to an exemplary embodiment, the component comprises a light emitting component arranged between the reflecting component and the light-transmitting component. According to an exemplary embodiment, the component provides at least one of the following optical effects: (a) a decorative effect and/or a color effect and/or a pattern effect and/or a surface effect and/or a texture effect provided by the component, and/or (b) a depth of field effect and/or a decorative effect and/or a color effect and/or a pattern effect and/or a surface effect and/or a texture effect provided by the surface of the light-transmitting component and/or the surface of the reflecting component, and/or (c) an illumination effect provided by incident light transmitted through the component, and/or (d) an illumination effect provided by incident light transmitted through the component and the surfaces of the light-transmitting component and the reflecting component. According to an exemplary embodiment, the component may provide rich and changeable reflection and transmission light effects for light transmittance; aesthetics and comfort of the interior trim part during use are improved. According to an exemplary embodiment, the component may be compact in structure, easy to assemble and low in cost. The component may be applied in various occasions to meet diversified requirements of users and improve the user experience.

### Exemplary Embodiments—C

According to an exemplary embodiment as shown schematically in the FIGURES, a component C for an interior VI of a vehicle V may comprise an improved interior trim part comprising a composite structure CS; the component C with the composite structure CS may comprise a light-transmitting component comprising a base layer and a coating layer and a reflecting component; the coating layer may be attached to a surface of the base layer; the component may be configured to provide a visual effect VF comprising an optical effect and/or an illumination effect. FIG. 1A is an overall schematic view of the exterior of a vehicle. FIG. 1B is an enlarged schematic view of the interior of a vehicle showing various suitable locations at that an interior trim part may be arranged. FIG. 2A is a schematic cross-sectional view of a light-transmitting component in an interior trim part according to one embodiment of the component showing a base layer and a coating layer. FIG. 2B is a schematic cross-sectional view of a light-transmitting component in an interior trim part according to an exemplary embodiment showing a base layer a coating layer and a light-transmitting surface layer. FIG. 2C is a schematic cross-sectional view of a light-transmitting component in an interior trim part according to an exemplary embodiment showing a base layer a coating layer a light-transmitting surface layer and a light-transmitting flexible layer. FIG. 3A is a schematic cross-sectional view similar to FIG. 2A showing a light-transmitting component in an interior trim part according to an exemplary embodiment in that a coating layer may comprise an opaque region and a light-transmitting region. FIG. 3B is a schematic cross-sectional view similar to FIG. 2B showing a light-transmitting component in an interior trim part according to an exemplary embodiment in that a coating layer may comprise an opaque region and a light-transmitting region. FIG. 3C is a schematic cross-sectional view similar to FIG. 2C showing a light-transmitting component in an interior trim part according to an exemplary embodiment in that a coating layer may comprise an opaque region and a light-transmitting region. FIG. 4A is a schematic side cross-sectional view of an interior trim part according to an embodiment of the component in that a reflecting component is a door panel and a light-transmitting component is an armrest. FIG. 4B is a schematic plan view of an interior trim part of FIG. 4A showing a distribution of light emitting components. FIG. 5A is a schematic side cross-sectional view of an interior trim part according to an exemplary embodiment, in that a reflecting component is a sub-instrument panel and a light-transmitting component is a trim or a cover over the sub-instrument panel. FIG. 5B is a schematic plan view of an interior trim part of FIG. 5A, showing the distribution of light emitting components

According to an exemplary embodiment as shown schematically in the FIGURES, the component shown as the interior trim part may comprise a composite structure comprising a light-transmitting component comprising a base layer and a coating layer attached to a surface of the base layer and a reflecting component; the reflecting component and the light-transmitting component are arranged at an interval; light may be transmitted out of the light-transmitting component through the coating layer and is partially projected on the reflecting component so as to present an optical effect on a surface of the light-transmitting component and a surface of the reflecting component. The light-transmitting component may comprise at least one of a textured structure, a pattern, and a color formed on one surface of the base layer. The surface of the base layer may be formed with a textured structure; the coating layer is attached to the surface with the textured structure. The coating layer may comprise an opaque region and a light-transmitting region, at least the opaque region may be attached to the surface with the textured structure. The surface of the base layer corresponding to the light-transmitting region may have a textured structure or a smooth surface. The smooth surface or the surface with the textured structure may be formed with at least one of a pattern and a color. The surface of the base layer corresponding to the light-transmitting region has a textured structure different from a textured structure corresponding to the opaque region. The coating layer may be a single-layer film or a multi-layer film stacked together. The textured structure may present a texture effect comprising at least one of a brushed texture, a checkered texture, a gradient texture, a starry-sky texture, a stone-like texture, a wood grain texture, a textile texture, a landscape texture, a crystal texture, a lens texture, a three-dimensional relief, a text, a figure, a symbol, a number, a beacon, and a trademark. The pattern may comprise at least one of a texture, a figure, a text, a symbol, a number, a beacon and a trademark. The pattern and/or the color may be formed by a single-layer film or a coating layer or a multi-layer film stacked together. The light-transmitting component may comprise a light-transmitting surface layer that covers a surface of the light-transmitting component. The light-transmitting surface layer may comprise any one of glass, plastic, film, wood veneer, leather, stone veneer, rubber, resin, fabric, and/or composite material. The light-transmitting component may comprise a light-transmitting flexible layer interposed between the light-transmitting surface layer and the base layer. The light-transmitting flexible layer may comprise any one of a mesh, and a foamed layer. The reflecting component and the light-transmitting component are vehicle interior components. The interior trim part may comprise a light emitting component arranged between the reflecting component and the light-transmitting component. The interior trim part may be configured to provide at least one of the following optical effects: (a) a decorative effect and/or a color effect and/or a pattern effect and/or a surface effect and/or a texture effect provided by the interior trim part; and/or (b) a depth of field effect and/or a decorative effect and/or a color effect and/or a pattern effect and/or a surface effect and/or a texture effect provided by the surface of the light-transmitting component and/or the surface of the reflecting component; and/or (c) an illumination effect provided by light transmitted through the interior trim part; and/or (d) an illumination effect provided by light transmitted through the interior trim part and the surfaces of the light-transmitting component and the reflecting component.

### Exemplary Embodiments—D

According to an exemplary embodiment, the specific examples discussed are merely illustrative of specific ways to make and use the component, and do not limit the scope of the present invention. The representation of the structural positions of the various components, e. g. up, down, top, bottom, etc. in the description is not absolute, but relative. These directional representations are appropriate when the various components are arranged as shown in the figures, but are correspondingly changed when the positions of the various components in the figures are changed.

According to an exemplary embodiment, the representations “including” or similar representations synonymous with “comprising”, “containing”, and “having” are open-ended and do not exclude additional unlisted elements, steps, or components.

According to an exemplary embodiment, the terms “more” and “multi-layer” are intended to mean two or more than two unless specifically limited otherwise.

According to an exemplary embodiment, when describing a light-transmitting component, “outer” and “inner” refer to directions with respect to a viewer, “outer” refers to a direction facing the viewer, and “inner” refers to a direction facing away from the viewer. When describing a vehicle component, “outside” and “inside” are directions relative to the inside and outside of the vehicle.

According to an exemplary embodiment, unless expressly and specifically limited otherwise, the terms “mounted”, “connected”, “attached”, and the like are to be construed broadly, and may be fixedly connected, detachably connected, or integrally connected; they may be directly connected or indirectly connected through an intermediate medium, and may be connected within two elements or in an interactive relationship between the two elements. The specific meaning of terms may be understood by those skilled in the art according to specific circumstances.

According to an exemplary embodiment, the term “vehicle” as referred to herein may comprise fuel vehicles, hybrid vehicles, electric vehicles, hydrogen-powered vehicles, and the like, and may be of various vehicle types, such as small cars, buses, rail vehicles, and the like, and is not intended to be limiting by way of illustration. According to an exemplary embodiment, the application of the interior trim part to a small car is mainly described, but it is not excluded that the component may be applied to other types of vehicles.

According to an exemplary embodiment, the thicknesses of the various layer structures in the light-transmitting component are in a range of thicknesses generally suitable for use in the art and are not intended to be limiting as shown in the figures. The light-transmitting component may be in the form of a curved surface. According to an exemplary embodiment; the surface of the light-transmitting component may be provided with special coatings or film layers to provide functions such as durability and/or comfort.

TABLE A
REFERENCE SYMBOL LIST

| REFERENCE | |
|---|---|
| SYMBOL | ELEMENT, PART OR COMPONENT |
| V | Vehicle |
| VI | Interior of vehicle |
| DP | Door Panel |
| IP | Instrument Panel |
| FC | Sub-Instrument Panel/Console (e.g. floor console) |
| C | Component |
| | (with composite structure with base/base layer and cover/cover layer |
| | (with light-transmitting element/component and light-reflecting element/surface) |
| CS | Composite structure |
| | (for light-transmitting element/component and light-reflecting element/surface) |
| T | Cover/cover layer |
| TC | Coating/film layer |
| BL | Base/base layer |
| NL | Intermediate layer |
| VF | Visual effect |
| VFx | Composite visual effect |
| | (e.g. visual effect at surface of component) |
| L | Light/illumination |
| E | Viewing angle/vantage point |
| 100 | Light-transmitting Component |
| 110 | Base Layer |
| 120 | Coating Layer |
| 200 | Light-transmitting Component |
| 210 | Base Layer |
| 220 | Coating Layer |
| 230 | Light-transmitting Surface Layer |
| 240 | Light assembly/element |
| | (light transmitting element) |
| | (Light Emitting Component (light element/lamp)) |
| 240a | Light Emitted by Light Emitting Component |
| 240b | Light Emitted by Light Emitting Component |
| 240x | Light element/assembly |
| 241 | Plate/base (PCB Plate) |
| 241x | Light reflecting element (Light reflector) |
| 242 | RGB Integrated Lamp Beads |
| 242x | Light reflecting elements |
| 250 | Textured Structure |
| 300 | Light-transmitting Component |
| 310 | Base Layer |
| 320 | Coating Layer |
| 330 | Light-transmitting Surface Layer |
| 340 | Light-transmitting Flexible Layer |
| 400 | Light-transmitting Component |
| 410 | Base Layer |
| 420 | Coating Layer |
| 421 | Opaque Region |
| 422 | Light-transmitting Region |
| 500 | Light-transmitting Component |
| 510 | Base Layer |
| 520 | Coating Layer |
| 521 | Opaque Region |
| 522 | Light-transmitting Region |
| 530 | Light-transmitting Surface Layer |
| 600 | Light-transmitting Component |
| 610 | Base Layer |
| 620 | Coating Layer |
| 621 | Opaque Region |
| 622 | Light-transmitting region |
| 630 | Light-transmitting Surface Layer |
| 640 | Light-transmitting Flexible Layer |
| 710 | Reflected Surface |
| 720 | Map Tape |
| 810 | Reflected Surface |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A component for a vehicle interior configured to present a composite visual effect comprising:
a composite structure comprising a base and a cover;
a light-transmitting element configured to transmit light to provide illumination for the composite structure;
a reflecting element configured to provide reflected light;
wherein the composite visual effect is configured to comprise illumination and reflected light presented at the composite structure.

2. The component of claim 1 wherein illumination from the light-transmitting element is configured to present a visual effect.

3. The component of claim 2 wherein reflected light from the reflecting element is configured to present a visual effect.

4. The component of claim 3 wherein the composite visual effect comprises the visual effect of reflected light from the reflecting element and the visual effect of illumination from the light-transmitting element.

5. The component of claim 1 wherein the reflecting element and the light-transmitting element are within the composite structure.

6. The component of claim 1 wherein the composite structure comprises an open space.

7. The component of claim 1 wherein the composite visual effect is presented at a surface of the cover of the composite structure.

8. The component of claim 2 wherein the visual effect of illumination from the light-transmitting element comprises light transmitted through the composite structure.

9. The component of claim 4 wherein the composite visual effect comprises the visual effect of reflected light from the reflecting element and the visual effect of illumination from the light-transmitting element and a visual effect from the cover of the composite structure and/or a visual effect from the base of the composite structure.

10. The component of claim 1 wherein the composite structure comprises an intermediate layer.

11. The component of claim 1 wherein the cover comprises a cover layer; wherein the cover layer comprises a coating and/or a film and/or a material.

12. The component of claim 1 wherein the reflecting element comprises a surface.

13. The component of claim 1 wherein the composite structure comprises a light-transmissive material.

14. The component of claim 13 wherein the composite structure comprises a generally opaque material.

15. The component of claim 1 wherein the composite structure comprises a light-transmitting structure and/or a light-reflecting surface.

16. The component of claim 1 wherein the composite visual image comprises at least one of a light effect and/or a dynamic lighting effect and/or a pattern effect and/or a texture effect and/or a color effect and/or a multi-color effect and/or a fabric effect and/or a brushed effect and/or a checkered effect and/or a gradient effect and/or a starry-sky effect and/or a stone-like effect and/or a wood grain effect and/or a textile effect and/or a landscape effect and/or a crystal effect and/or a layered effect and/or a lens effect and/or a three-dimensional effect and/or text and/or an image and/or a figure and/or a symbol and/or a number and/or a beacon and/or a logo.

17. The component of claim 1 wherein the composite structure comprises a light-transmitting structure comprising a light-transmitting material comprising at least one of glass and/or plastic and/or film and/or wood veneer and/or leather and/or synthetic leather and/or stone veneer and/or elastomer and/or rubber and/or plastic and/or resin and/or fabric and/or textile and/or composite material and/or a flexible layer and/or a 3D mesh and/or a foamed layer and/or a foam material.

18. The component of claim 1 wherein the composite visual effect is configured to comprise a visual effect of illumination comprising at least one of a decorative effect and/or a color effect and/or a pattern effect and/or a surface effect and/or a texture effect and/or a depth of field effect.

19. The component of claim 1 wherein the composite visual effect is configured to comprise a visual effect of reflected light comprising at least one of a decorative effect and/or a color effect and/or a pattern effect and/or a surface effect and/or a texture effect and/or a depth of field effect.

20. The component of claim 1 wherein the composite visual effect is configured to comprise at least one of a decorative effect and/or a color effect and/or a pattern effect and/or a surface effect and/or a texture effect and/or an illumination effect and/or a reflection effect and/or a light reflection effect and/or a light absorption effect and/or a light refraction effect and/or light transmission effect and/or light multi-reflection effect and/or light multi-transmission effect and/or a direct light effect and/or an optical effect and/or a combination of optical effects and/or a combination of illumination effects and/or a combination of reflective effects and/or a reflective effect and an illumination effect and/or a color effect and/or a multi-color effect and/or a superimposed illumination effect and/or a superimposed illumination effect by multi-reflection with refraction and/or an optical effect comprising an aesthetic effect and/or a multi-aesthetic effect and/or a varying optical effect and/or a dynamic lighting effect and/or a random pattern effect and/or a repeating pattern effect.
